(19) United States
(12) Patent Application Publication
(10) Pub. No.: US 2014/0279505 A1
(43) Pub. Date: Sep. 18, 2014

(54) RECOMMENDING VEHICLE FOR PAYMENT BASED ON SOCIAL NETWORK DATA

(71) Applicant: BANK OF AMERICA CORPORATION, Charlotte, NC (US)

(72) Inventors: David M. Grigg, Rock Hill, SC (US); Matthew A. Calman, Charlotte, NC (US); Scott Lee Harkey, Concord, NC (US); Laura Corinne Bondesen, Charlotte, NC (US); Robert Scott Ellis, Aston, PA (US)

(73) Assignee: BANK OF AMERICA CORPORATION, Charlotte, NC (US)

(21) Appl. No.: 13/803,682

(22) Filed: Mar. 14, 2013

(51) Int. Cl. G06Q 20/22

(52) U.S. Cl. CPC G06Q 20/227
USPC 705/44

(57) ABSTRACT

Embodiments of the invention are directed to a system, method, or computer program product for recommending payment vehicles for a transaction based on social network data. Embodiments of the invention allow a customer to receive a recommended payment vehicle for a transaction with a merchant where the recommended payment vehicle is determined based on social network data. In this way, a payment recommendation may be based on one or more preferences of a trusted advisor, social network friend, family member, celebrity, or an aggregation of data related to how a group of individuals on a social network are selecting payment vehicles for various merchants. The invention may review this social network data and provide the customer with a payment vehicle recommendation for a transaction with a merchant.

### BACKGROUND

Customers typically have a variety of payment options when entering into a transaction with a business, such as but not limited to cash, check, gift cards, credit cards, debit cards, or the like. Payment options, such as a credit or debit card, may be issued through financial institutions, retail stores, gas stations, airlines, and other businesses. Often, the businesses that issue the payment option provide promotions such as reward points, travel miles, cash back bonuses, product or store discounts, free gifts, or the like.

Selecting a payment option for a transaction may be as easy as grabbing the first credit card out of the customer's wallet or selecting a payment option for a transaction may be difficult and include many factors.

Utilizing a proper payment option when making a transaction may provide additional value to the customer, by maximizing the profitability from a transaction.

### BRIEF SUMMARY

Embodiments of the present invention address the above needs and/or achieve other advantages by providing apparatuses (e.g., a system, computer program product and/or other devices) and methods for recommending payment vehicles for a transaction. The recommendation may be proactive, retroactive, based on rewards, or based on social network data. Either way, the recommendation allows a customer to enter into a financial transaction with a merchant where the customer's payment may be directed to an appropriate payment account in order to maximize the customer's profitability from the transaction or to obtain customer's goals quickly.

The invention may provide recommended payment vehicles for a customer to use during a transaction that maximizes the positive implications for the customer. As such, the recommended payment vehicle may be one or more payment vehicles that maximize positive profit for the customer, such as provide the most rewards, cash back, frequent flyer miles, lowest percentage interest, correct balances, and/or the like. The recommended payment vehicle for a customer to use during a transaction may be proactive, retroactive, based on rewards, or based on social network data.

In some embodiments, the recommended payment vehicle may be determined proactively. As such, the invention allows for proactive payment vehicle recommendations for a customer transaction. In this way, the invention may provide the customer with a recommended payment vehicle for a product proactively, that is, based on predetermined criteria based on one or more of customer inputs, determined defaults, in-flow, out-flow, or the like. In this way, the invention, prior to a purchase being made, may determine a recommended payment vehicle for the customer to utilize to complete the transaction. Subsequently, the invention may notify the customer of the recommended payment vehicle prior to the customer entering into the transaction.

In some embodiments, the recommended payment vehicle may be determined retroactively. As such, the invention allows for retroactive payment vehicle recommendations for a customer transaction. In this way, the invention provides retroactive payment vehicle recommendation after the transaction based on criteria from customer inputs, in-flow, out-flow, or the like. In this way, in some embodiments, the invention may complete the transaction using a temporary line of credit, and subsequently apply the transaction to the recommended payment vehicle. Then the temporary line of credit may be terminated.

In some embodiments, the recommended payment vehicle may be determined based on payment vehicle rewards. As such, the invention allows for payment vehicle recommendations for a customer transaction based on potential rewards available for the one or more payment vehicles the customer has available for a transaction. For example, if a customer receives three times rewards for purchasing products using one payment vehicle versus two times rewards for purchasing the product with a second payment vehicle, the invention may recommend the vehicle based on the higher rewards for the products of the transaction.

In some embodiments, the recommended payment vehicle may be determined based on social network data. As such, the invention allows for payment vehicle recommendations for a customer transaction based on social network data associated with the customer. In this way, a payment recommendation may be based on one or more preferences of a trusted advisor, social network friend, family member, celebrity, or an aggregation of data related to how a group of individuals on a social network are selecting payment vehicles for various merchants.

Embodiments of the invention relate to systems, methods, and computer program products for recommending a payment vehicle for a transaction based on social network data, the invention comprising: determining one or more payment vehicles available to a customer; reviewing social network data associated with the customer; receiving an indication of a potential transaction between the customer and a merchant; determining transaction details associated with the potential transaction between the customer and the merchant, wherein the transaction details include merchant type and products of the potential transaction; determining a recommended payment vehicle for the potential transaction, wherein the recommended payment vehicle is determined based at least in part on the one or more payment vehicles available to the customer, the social network data associated with the customer, and the transaction details; determining that the transaction has been initiated between the customer and the merchant; providing the customer with the recommended payment vehicle before the transaction has been completed between the customer and the merchant; and applying the recommended payment vehicle to the transaction to complete the transaction, wherein applying the recommended payment vehicle to the transaction is based at least in part on customer authorization.

In some embodiments, social network data associated with the customer comprises one or more preferences of customer social network connections, such as a trusted advisor, social network friend, social network following, or aggregate of preferences of a social network group. In some embodiments, social network data associated with the customer further comprises posts, likes, messages, or links on a social network associated with the customer social network connections.

In some embodiments, determining a recommended payment vehicle for the potential transaction further comprises determining a payment vehicle that the customer social network connections have used in a similar transaction with the merchant or a similar transaction for a product of the transaction.

In some embodiments, an indication of a potential transaction between the customer and a merchant is determined by one or more customer location identification, customer communication, merchant communication, or social network data.

In some embodiments, determining the one or more payment vehicles available to the customer further comprises determining, automatically, the one or more payment vehicles available to the customer based on social network data or customer inputs, wherein the one or more payment vehicles available to the customer comprise cash, credit card account, a debit card account, a line of credit account, a retail card, a savings account, an investment account, or a line of credit.

In some embodiments, the invention further comprises receiving a customer enrollment indication such that the customer authorizes access to the payment vehicles available to the customer and the social network data associated with the customer.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating a general recommendation of payment vehicle determination process, in accordance with one embodiment of the present invention;

FIG. 2 provides a recommendation of payment vehicle determination system environment, in accordance with one embodiment of the present invention;

FIG. 3 provides a process map illustrating a proactive recommendation of payment vehicle set up process, in accordance with one embodiment of the present invention;

FIG. 4 provides a process map illustrating a proactive recommendation of payment vehicle process, in accordance with one embodiment of the present invention;

FIG. 5 provides a process map illustrating a retroactive recommendation of payment vehicle set up process, in accordance with one embodiment of the present invention;

FIG. 6 provides a process map illustrating a retroactive recommendation of payment vehicle process, in accordance with one embodiment of the present invention;

FIG. 7 provides a process map illustrating a rewards based recommendation of payment vehicle set up process, in accordance with one embodiment of the present invention;

FIG. 8 provides a process map illustrating a rewards based recommendation of payment vehicle process, in accordance with one embodiment of the present invention;

FIG. 9 provides a process map illustrating a social network based recommendation of payment vehicle set up process, in accordance with one embodiment of the present invention; and

FIG. 10 provides a process map illustrating a social network based recommendation of payment vehicle process, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Furthermore, the term “payment vehicle” or “payment account” as used herein may include any method of payment for purchasing a product or service. Payment vehicles may include, but are not limited to cash, credit cards, debit cards, lines of credit, checks, debit notes, payment accounts, fund accounts, or the like. The term “product” as used herein may include any product, service, or the like that may be purchased or obtained from a merchant.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that offer payment account systems to customers.

Some portions of this disclosure are written in terms of a financial institution's unique position with respect to customer transactions. As such, a financial institution may be able to utilize its unique position to receive, store, process, and retrieve information associated with transactions.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the customer and the merchant, e.g. financial institution, or other entity monitoring the customer's activities. In some embodiments, for example, a transaction may refer to a purchase of goods or services, a return of goods or services, a payment transaction, a credit transaction, or other interaction involving a customer's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the user and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a customer's device, such as a customer's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the customer's perspective, the merchant's perspective or both. In some embodiments, the point-of-transaction device refers only to a customer's device, in other embodiments it refers only to a merchant device, and in yet other embodiments, it refers to both a customer device and a merchant device interacting to perform a transaction. For example, in one embodiment, the point-of-transaction device refers to the customer's mobile device configured to communicate with a merchant's point of sale terminal, whereas in other embodiments, the point-of-transaction device refers to the merchant's point of sale terminal configured to communicate with a customer's mobile device, and in yet other embodiments, the point-of-transaction device refers to both the customer's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a customer may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the customer of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

FIG. 1 illustrates a high level process flow for a general recommendation of payment vehicle determination process 100, in accordance with one embodiment of the present invention, which will be discussed in further detail throughout this specification with respect to FIGS. 2 through 10. The first step in the process 100, as illustrated in block 102, is to receive an indication of a transaction occurring between a customer and a merchant. A customer, as used herein may include, but is not limited to, a user, individual, person, entity, or other individual that may enter into a transaction with a merchant. Next, as illustrated in block 104, once a transaction has been initiated between a customer and a merchant, the system determines the type of transaction. The type of transaction may be online, offline, type of merchant, at a brick and mortar store location, over the phone, or the like. The transaction may be for a product, service, or the like.

Next, as illustrated in block 106, the system may select a recommended payment vehicle for the transaction between the customer and the merchant. The recommended payment vehicle may be determined proactively, retroactively, based on rewards, or based on social network data. In this way, the recommendation allows a customer to enter into a financial transaction with a merchant where the customer's payment may be directed to an appropriate or recommended payment account in order to maximize the customer's profitability from the transaction or to obtain customer's goals quickly. Finally, as illustrated in block 108, in some embodiments, the system may be able to apply the transaction amount from the transaction between the customer and the merchant to the recommended payment vehicle. In this way, in some embodiments, payment for completion of the transaction may be directed to the recommended payment vehicle.

FIG. 2 provides a recommendation of payment vehicle determination system environment 200, in accordance with one embodiment of the present invention. As illustrated in FIG. 2, the financial institution server 208 is operatively coupled, via a network 201 to the customer system 204, to the point-of-transaction (POT) system 206, and to other financial institution systems 210. In this way, the financial institution server 208 can send information to and receive information from the customer system 204, the POT system 206, and other financial institution systems 210, to provide and apply recommended payment vehicles to transactions between customers 202 and merchants. FIG. 2 illustrates only one example of an embodiment of a recommendation of payment account determination system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual making a financial transaction. The financial transaction may be made at a POT system 206 of a merchant, online or offline, over the phone, at the merchant's place of business and/or other transaction means. The purchase may be made by the customer 202 using a customer system 204, such as a mobile wallet (i.e. smart phone, PDA, and the like) or other types of payment systems that communicate with POS systems 206 and/or financial institution servers 208 to allow the customer 202 to receive recommended payment vehicles and to make/complete a transaction. In some embodiments of the invention, the customer 202 may enter into transactions using a card with stored magnetic information, digital information, or other like payment device that stores information that may be transferred to a POT system 206 and/or a financial institution server 208 to allow a customer 202 to enter into a transaction. In some embodiments, the customer 202 may be a merchant or a person, employee, agent, independent contractor, and the like acting on behalf of the merchant to enter into a transaction.

As illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the POT system 206, the customer system 204, and the other financial institution computer systems 210. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of an account application 258. In some embodiments, the computer-readable instructions 254 include a system payment application 256. In some embodiments, the memory device 250 includes data storage 252 for storing data related to the recommendation of payment vehicles including but not limited to data created and/or used by the account application 258 and/or the system payment application 256.

In the embodiment illustrated in FIG. 2 and described throughout much of this specification, the system payment application 256 allows for recommendations proactively, retroactively, rewards based, or social network based. As such, the data stored within the system payment application 256 provides computer readable instructions 254 to the processing device 248 to allow for recommendation and/or selection of a recommended payment vehicle for a transaction.

The system payment application 256 allows for proactive payment vehicle recommendations for a customer 202 transaction. In this way, the invention may provide the customer 202 with a recommended payment vehicle for a product proactively, that is, based on predetermined criteria based on one or more of customer input, determined defaults based on in-flow and/or out-flow, or the like. In this way, the system payment application 256 may, prior to a purchase being made, determine a recommended payment vehicle for the customer 202 to utilize to complete the transaction.

The system payment application 256 may identify a customer 202 enrollment into the proactive recommendation process. Once enrolled, the customer 202 may input criteria, such as preferred payment vehicles, available payment vehicles, preferences, future events that the customer 202 may be planning, or the like. Next, the system payment application 256 may review the inputs and communicate with the account application 258.

In some embodiments, the system payment application 256 may receive predetermined criteria from one or more customer 202 inputs. In this way, a customer 202 may input one or more criteria, such as preferred payment vehicles, available payment vehicles, preferences, future events that the customer 202 may be planning, or the like. This way, the system payment application 256 may be able to take this inputted data and generate a recommendation for a payment vehicle for a specific transaction. For example, if the customer 202 is planning a vacation, the payment vehicle may be a Credit Card with frequent flyer miles associated therewith.

In some embodiments, the system payment application 256 may determine a proactive recommendation based on customer 202 in-flows and/or out-flows. Customer 202 in-flows may include one or more financial aspects associated with the customer 202 flowing into the customer's accounts or payment vehicles on a daily/weekly/monthly/yearly basis. In this way, the in-flow may include one or more paychecks, realized gains, checks, deposits, or other monetary in-flow. In-flow may also include typical customer 202 savings or money management routines. Customer 202 out-flow may include one or more financial aspects associate with the customer 202 flowing out of the customer's accounts or payment vehicles. In this way, the out-flows may include one or more payments for expenses, taxes, bills, or the like that are typically flowing out from the customer 202 on a daily/weekly/monthly/yearly basis.

Once enrolled, the system payment application 256 may review the criteria and the in-flows and out-flows for the customer 202. As such, the system payment application 256 may determine recommended payment vehicles for frequently visited merchants.

The system payment application 256 may then identify when a customer 202 enters a location associated with a merchant. In this way, the system payment application 256 may identify that a transaction may occur between the customer 202 and the merchant. This may be done via identification from the customer 202 that the customer 202 is about to enter into the transaction or by identifying/monitoring the location of the customer 202 via the customer system 204. As such, the system payment application 256 is in communication with the customer system 204 through the communication device 246 and network 201.

Once identified, the system payment application 256 may determine the merchant of the potential transaction. As such, the system payment application 256 may determine the classification of the merchant, such as a department store, grocery store, gas station, or the like. Furthermore, based on location data, such as global position systems (GPS) associated with the customer system 204, the system payment application 256 may determine the store name, such as Gas Station 1 or Department Store 2.

Upon determining the merchant of the potential transaction, the system payment application 256 may in combination with the information on the account application 258 may determine proactively payment vehicle recommendation. As such, using one or more of the customer 202 input, in-flow, out-flow, or other criteria the system payment application 256 may determine a recommended payment vehicle for the transaction.

In some embodiments, the system payment application 256 may provide the recommended payment vehicle to the customer 202 by communicating the payment vehicle to the customer system 204 via the network 201. In some embodiments, the customer 202 may utilize the recommended payment vehicle to complete the transaction at the merchant. In some embodiments, the customer 202 may utilize a different payment vehicle to complete the transaction with the merchant. In some embodiments, the customer 202 may not find a product to purchase at the merchant.

In some embodiments, the system payment application 256 may, upon receiving an indication from the customer 202, complete the transaction by applying the recommended payment vehicle to the transaction. In this way, the system payment application 256 may communicate the recommended payment vehicle to the POT system 206 via the network 201. As such, the system payment application 256 may provide the payment vehicle to the vendor for the customer 202 transaction. This way, the transaction may be processed utilizing the information about the payment vehicle that the POT system 206 received from communication with the system payment application 256.

The system payment application 256 allows for retroactive payment vehicle recommendations for a customer 202 transaction. In some embodiments, the recommended payment vehicle may be determined retroactively. As such, the system payment application 256 may allow for retroactive payment vehicle recommendations for a customer transaction. In this way, the system payment application 256 may provide retroactive payment vehicle recommendation after the transaction based on criteria from customer inputs, in-flow, out-flow, or the like. In this way, in some embodiments, the system payment application 256 may communicate with the POT system 206 to complete the transaction using a temporary line of credit, and subsequently apply the transaction to the recommended payment vehicle. Then the temporary line of credit may be terminated.

In some embodiments, as described above, the system payment application 256 may identify a customer 202 enrollment into the retroactive recommendation process. Once enrolled, the customer 202 may input criteria, such as preferred payment vehicles, available payment vehicles, preferences, future events that the customer 202 may be planning, or the like. In some embodiments, the customer 202 input criteria may be inputted after the transaction has been completed. Next, the system payment application 256 may review the inputs and communicate with the account application 258.

Next, the system payment application 256 may review the criteria (if inputted) and the in-flows and out-flows for the customer 202. The system payment application 256 may then receive an indication of a transaction between a merchant and the customer 202. This indication may be communicated between a POT system 206 and the system payment application 256 via the network 201. In other embodiments, the indication may be communicated between the customer system 204 and the system payment application 256. In this way, the system payment application 256 may recognize an indication of the products of the transaction and the merchant of the transaction.

Once the transaction has been initiated, the system payment application 256 may determine when the transaction has been completed. Upon completion the system payment application 256 may receive a list of the products of the transaction and the price associated therewith. While the system payment application 256 may receive an indication of the products of the transaction during the transaction, this list indicates the completion of the transaction, the total price of the transaction, and the like. This list may be sent from the POT system 206 through the network 201 to the system payment application 256.

Next, once the products have been scanned by the merchant, in order to complete the transaction payment must be tendered by the customer 202 to the merchant. In some embodiments, the financial institution may, via the system payment application 256 provide a temporary line of credit to the merchant's POT system 206 to complete the transaction for the customer 202. In this way, the temporary line of credit may be applied to the transaction to complete the transaction.

Subsequently, after the transaction the system payment application 256 may in combination with the information on the account application 258 determine retroactively a payment vehicle recommendation for the transaction. As such, using one or more of the customer 202 input, in-flow, out-flow, or other criteria the system payment application 256 may determine a recommended payment vehicle for the transaction.

In some embodiments, the system payment application 256 may provide the recommended payment vehicle to the customer 202 by communicating the payment vehicle to the customer system 204 via the network 201. In some embodiments, the customer 202 may utilize the recommended payment vehicle to satisfy the temporary line of credit. As such, the temporary line of credit may be closed and the amount associated with the transaction may be applied to the retroactively determined payment vehicle. In this way, the system payment application 256 may communicate with the POT system 206, the customer system 204, and the other financial institution systems 210 to complete the transaction with the temporary line of credit, subsequently apply the transaction to the recommended payment vehicle, and close the temporary account.

In some embodiments, the system payment application 256 may, upon receiving an indication from the customer 202, complete the transaction by applying the recommended payment vehicle to the transaction. In this way, the system payment application 256 may communicate the recommended payment vehicle to the POT system 206 via the network 201. As such, the system payment application 256 may provide the payment vehicle to the vendor for the customer 202 transaction. This way, the transaction may be processed utilizing the information about the payment vehicle that the POT system 206 received from communication with the system payment application 256.

The system payment application 256 allows for rewards based payment vehicle recommendations for a customer 202 transaction. As such, the system payment application 256 allows for payment vehicle recommendations for a customer 202 transaction based on potential rewards available for the one or more payment vehicles the customer 202 has available for a transaction. For example, if a customer 202 receives three times rewards for purchasing products using one payment vehicle versus two times rewards for purchasing the product with a second payment vehicle, the invention may recommend the vehicle based on the higher rewards for the products of the transaction. In this way, in some embodiments, the system payment application 256 may communicate with the POT system 206 to complete the transaction using the recommended payment vehicle based on rewards associated with the merchant, a product of the transaction, or all of the products of the transaction. In some embodiments, one product may have a different recommended payment vehicle than another product within the same transaction based on rewards.

In some embodiments, as described above, the system payment application 256 may identify a customer 202 enrollment into the rewards based recommendation process. Once enrolled, the system may determine available payment vehicles for the customer 202. In some embodiments, the system may determine the available payment vehicles for the customer 202. In other embodiments, the customer 202 may input available payment vehicles into the system. Customer 202 input may also include other criteria, such as preferred payment vehicles, preferences, future events that the customer 202 may be planning, or the like.

Next, the system payment application 256 may determine the reward criteria for each of the one or more available payment vehicles. The rewards for each of the one or more payment vehicles may include, but is not limited to cash back rewards, discounts, coupons, frequent flyer miles, points, balance transfer bonuses, product rewards, and/or the like. In this way the system payment application 256 may communicate with issuing entities for the payment vehicles, such as other financial institution systems 210, to determine the rewards for each of the one or more available payment vehicles. The system payment application 256 may continually communicate with issuing entities such that changes in rewards, special promotional periods, or the like may be recognized by the system payment application 256.

Once a transaction has been initiated between a customer 202 and a merchant, the system payment application 256 may determine when the transaction has been completed. Upon completion the system payment application 256 may receive a list of the products of the transaction and the price associated therewith. While the system payment application 256 may receive an indication of the products of the transaction during the transaction, this list indicates the completion of the transaction, the total price of the transaction, and the like. This list may be sent from the POT system 206 through the network 201 to the system payment application 256.

Next, the system payment application 256 may utilize the list of products as well as the merchant associated with the transaction in order to determine payment vehicle rewards associated with the merchant or the products of the transaction. In some embodiments, the rewards may be associated with all of the products of the transaction. In some embodiments, the rewards may be associated with one of the products of the transaction.

Then the system payment application 256 may determine a recommended payment vehicle based on the rewards, customer inputs, and/or the like. The recommended payment vehicle may be presented to the customer 202 via system payment application 256 communication with the customer system 204 via the network 201. In this way, the customer 202 may utilize the recommended payment vehicle to complete the transaction with the payment vehicle. In other embodiments, the system payment application 256 may communicate directly to the POT system 206 to complete the transaction by applying the recommended payment vehicle to the transaction.

The system payment application 256 allows for social network based payment vehicle recommendations for a customer 202 transaction. As such, the system payment application 256 may determine the recommended payment vehicle based on social network data. As such, the system payment application 256 allows for payment vehicle recommendations for a customer transaction based on social network data associated with the customer. In this way, a payment recommendation may be based on one or more preferences of a trusted advisor, social network friend, family member, celebrity, or an aggregation of data related to how a group of individuals on a social network are selecting payment vehicles for various merchants. For example, the system payment application 256 may review a trusted advisor's social network inputs, connections, or the like to determine a recommended payment vehicle for a customer 202 associated with the trusted advisor. At this point, in some embodiments, the system payment application 256 may communicate with the POT system 206 to complete the transaction using the recommended payment vehicle based on social network data associated with the customer 202. Social network data may include one or more of preferences of a trusted advisor, social network friend, family member, celebrity, or an aggregation of data related to how a group of individuals on a social network as well as following/followers, posts, likes, messages, links, or the like associated with the advisor, friend, family member, celebrity, or group of individuals. Furthermore, the connections associated with the advisor, friend, family member, celebrity, or group of individuals may also be analyzed as social network data.

In some embodiments, as described above, the system payment application 256 may identify a customer 202 enrollment into the social network data based payment vehicle recommendation process. Once enrolled, the system may determine available payment vehicles for the customer 202. In some embodiments, the system may determine the available payment vehicles for the customer 202. In other embodiments, the customer 202 may input available payment vehicles into the system.

Next, the system payment application 256 may review social network data. The system payment application 256 may communicate over the network 201 to retrieve and review social network data, such as that which is described above. The system payment application 256 may continually monitor social networks to receive new, up-to-date social network data for payment vehicle recommendations.

Once a transaction has been initiated between a customer 202 and a merchant, the system payment application 256 may determine when the transaction has been completed. Upon completion the system payment application 256 may receive a list of the products of the transaction and the price associated therewith. While the system payment application 256 may receive an indication of the products of the transaction during the transaction, this list indicates the completion of the transaction, the total price of the transaction, and the like. This list may be sent from the POT system 206 through the network 201 to the system payment application 256.

Next, the system payment application 256 may utilize the list of products as well as the merchant associated with the transaction in order to determine a recommended payment vehicle based on the social network data.

The recommended payment vehicle may be presented to the customer 202 via system payment application 256 communication with the customer system 204 via the network 201. In this way, the customer 202 may utilize the recommended payment vehicle to complete the transaction with the payment vehicle. In other embodiments, the system payment application 256 may communicate directly to the POT system 206 to complete the transaction by applying the recommended payment vehicle to the transaction.

As illustrated in FIG. 2, the financial institution server 208 further comprises an account application 258. The account application 258 stores payment vehicles and information associated therewith to aid the system payment application 256 in determining recommended payment vehicles proactively, retroactively, based on rewards, or based on social network. These information may including, but not limited to payment vehicles available to a customer 202, preferred vehicles of a customer 202, customer preferences, in-flow and out-flow of a customer 202, general information associated with payment vehicles, rewards associated with payment vehicles, other promotions associated with payment vehicles, social network data associated with the customer 202, social network data associated with the customer's connections, and/or the like.

In this way, the account application 258 is connected to the system payment application 256, such that the system payment application 256 has access to the stored payment vehicles and information associated therewith. This information is retrieved and stored via the account application 258. In this way, the account application 258 may have information associated with each of the one or more payment vehicles a customer 202 may have. Furthermore, the account application 258 may also receive and store information associated with how the customer 202 utilizes the payment vehicle or trends associated with the payment vehicle. For example, if the customer 202 always uses Credit Card 1 to purchase gas, the account application 258 may recognize this trend and associate that trend with Credit Card 1. Furthermore, the account application 258 may have issuing entity information associated with each payment vehicle. This issuing entity information may comprise one or more rewards, functions, features, or the like associated with the payment vehicle. For example, Credit Card 2 may have a percent cash back for a specific type of purchase or purchase location. Finally, the account application 258 may determine and/or receive in-flow and out-flow data associated with customer 202 finances. In this way, the account application 258 may determine the money flowing into the customer 202 on a daily/weekly/monthly/yearly basis and typical out-flow such as payments for expenses, bills, or the like that are typically flowing out from the customer 202 on a daily/weekly/monthly/yearly basis.

As illustrated in FIG. 2, the POT system 206 generally comprises a reading device 235, a communication device 236, a processing device 238, and a memory device 240. The reading device 235 is operatively coupled to the processing device 238, communication device 236, and the memory device 240. The POT system 206 may include a reader device 235 to receive payment vehicle information from the customer 202 through the customer system 204 and/or other payment devices. Such a reader device 235 may include a magnetic strip reader, a barcode scanner, a radio frequency (RF) reader, a character recognition device, a magnetic ink reader, a processor for interpreting codes presented over an electrical or optical medium, a biometric reader, a wireless receiving device, and/or the like. In some embodiments, the reading device 235 receives information that may be used to identify the consumer's payment account and/or transaction data at the POT system 206 and communicates the information via the communication device 236 over a network 201, to other systems such as, but not limited to the financial institution server 208, other financial institution systems 210, and/or the customer system 204. As such, the communication device 236 generally comprises a modem, server, or other device for communicating with other devices on the network 201.

As further illustrated in FIG. 2, the POT system 206 comprises computer-readable instructions 242 stored in the memory device 240, which in one embodiment includes the computer-readable instructions 242 of a merchant payment application 244.

In the embodiment illustrated in FIG. 2, the merchant payment application 244 allows the POT system 206 to be linked to the financial institution server 208 and other financial institution systems 210 to communicate, via a network 201, the information related to the transaction being made, such as the transaction type, cost, product type, merchant location, and the like. In one example, the customer 202 enters into a transaction at a POT system 206, which processes the transaction and the merchant payment application 244 allows communication of the transaction information to the financial institution server 208. Furthermore, the financial institution server 208 or other financial institution systems 210 may communicate with the merchant payment application 244 to provide the POT system 206 with the recommended payment vehicle to apply to the transaction for the customer 202.

FIG. 2 also illustrates a customer system 204. The customer system 204 generally comprises a communication device 212, a processing device 214, and a memory device 216. The customer system 204 is a computing system that allows a customer 202 to enter into transactions, via a network 201, with the POT system 206, and/or supply the system payment application 256 with payment account information and input criteria (such as preferences) to determine recommended payment vehicles. The processing device 214 is operatively coupled to the communication device 212 and the memory device 216. The processing device 214 uses the communication device 212 to communicate with the network 201 and other devices on the network 201, such as, but not limited to the POT system 206, the financial institution server 208, and the other financial institution computer systems 210. As such, the communication device 212 generally comprises a modem, server, or other device for communicating with other devices on the network 201.

As further illustrated in FIG. 2, the customer system 204 comprises computer-readable instructions 220 and data storage 218 stored in the memory device 216, which in one embodiment includes the computer-readable instructions 220 of a customer payment application 222. In this way, a customer 202 may be able to enter into transactions at the POT system 206, provide inputs for recommendation, view received recommendations form the financial institution server 208, and confirm selected payment vehicles through the financial institution server 208, using the customer payment application 222. The customer system 204 may be, for example, a desktop personal computer, a mobile system, such as a cellular phone, smart phone, personal data assistant (PDA), laptop, or the like. Although only a single customer system 204 is depicted in FIG. 2, the payment account determination system environment 200 may contain numerous customer systems 204.

The other financial institution systems 210 are operatively coupled to the financial institution server 208, the POT system 206, and/or the customer system 204 through the network 201. The other financial institution systems 210 have systems with devices the same or similar to the devices described for the financial institution server 208, the POT system 206, and/or the customer system 204 (i.e., communication device, processing device, and memory device). Therefore, the other financial institution systems 210 communicate with the financial institution server 208, the POT system 206, and/or the customer system 204 in the same or similar way as previously described with respect to each system. The other financial institution computer systems 210, in some embodiments, are comprised of systems and devices that allow the customer 202 and the financial institution server 208 to access payment vehicle information at the financial institution and/or allow transactions using the customer 202 payment vehicles at the other financial institutions.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 3 illustrates a process map for a proactive recommendation of payment vehicle set up process 300, in accordance with one embodiment of the present invention. First, as illustrated in block 302 the process 300 may be initiated when a customer 202 enrolls in the proactive recommendation of payment vehicle process. The customer 202 may be able to enroll in the program by selecting a link provided by the financial institution to download an application on the customer system or to enroll through an online banking application provided by the financial institution or through the other financial institution systems 210.

Next, as illustrated in block 304 the customer 202 may input the payment vehicles he/she has available, irrespective of the issuing entity. Next, at block 306, the customer 202 may input any criteria or default inputs into the process. In this way, a customer 202 may input one or more criteria, such as preferred payment vehicles, preferences in payment vehicles for various merchants, future events that the customer 202 may be planning, or the like. Next, as illustrated in block 308, the system may determine system defaults for the payment vehicle selection. These system defaults may be based at least in part on the customer 202 inputs, such that the system may recognize default payment recommendations based on the customer's 202 historic payment vehicle uses.

As illustrated in block 310 of FIG. 3, the process 300 continues at block 310 where the system may determine and review typical in-flow and out-flow associated with the customer 202. Customer 202 in-flows may include one or more financial aspects associated with the customer 202 flowing into the customer's accounts or payment vehicles on a daily/weekly/monthly/yearly basis. In this way, the in-flow may include one or more paychecks, realized gains, checks, deposits, or other monetary in-flow. In-flow may also include typical customer 202 savings or money management routines. Customer 202 out-flow may include one or more financial aspects associate with the customer 202 flowing out of the customer's accounts or payment vehicles. In this way, the out-flows may include one or more payments for expenses, taxes, bills, or the like that are typically flowing out from the customer 202 on a daily/weekly/monthly/yearly basis. Furthermore, not only are in-flows and out-flows reviewed, customer 202 transaction history may be included in the out-flows, such that the system may recognize trends associated with purchases from various merchants. For example, a customer 202 may have always use Debit Card 2 at Merchant B in the past. As such, the system may take into consideration the customer's transaction history with Merchant B when recommending a payment vehicle for a transaction with Merchant B. Finally, as illustrated in block 312, the set up for proactive recommendation of payment vehicle process 300 is completed.

FIG. 4 provides a process map illustrating a proactive recommendation of payment vehicle process 400, in accordance with one embodiment of the present invention. In this way, proactive recommendation of payment vehicle process 400 may provide the customer 202 with a recommended payment vehicle for a product proactively, that is, based on predetermined criteria based on one or more of customer input, determined defaults, in-flow and/or out-flow, or the like. In this way, the process 400 may, prior to a purchase being made, determine a recommended payment vehicle for the customer 202 to utilize to complete the transaction.

As illustrated in block 402, an indication is received of the potential for a transaction between the customer and a merchant. This indication may include identifying when a customer 202 enters a location associated with a merchant. In this way, when the customer 202 enters a merchant may indicate that a transaction may occur between the customer 202 and the merchant. This may be done via identification from the customer 202 that the customer 202 is about to enter into the transaction or by identifying/monitoring the location of the customer 202 via GPS or other location identification based means. As illustrated in block 404, the process 400 determines the potential products of the transaction and the merchant of the transaction. First, the merchant may be determined. Again, this may be done using GPS or location based identification means that identify a customer 202 within a location associated with a merchant. This may also be done by identifying a customer 202 accessing a merchant website or the like. As such, the classification of the merchant may be determined, such as a department store, grocery store, gas station, or the like. Furthermore, more specifically, the store name may be determined, such as Gas Station 1 or Department Store 2. From this data, the system may be able to determine the products of the transaction. Such as gasoline, groceries, clothing, or the like based on the classification of merchant identified.

Next, as illustrated in block 406, the system may determine a recommended payment vehicle for the transaction once the potential products and merchant has been identified. The recommended payment vehicle for the transaction is determined based on one or more of inputted customer defaults 408, system identified defaults 410, typical in-flow 412, and typical out-flow 414, which are described in more detail above with respect to FIG. 3.

Next, as illustrated in block 416, the process proactively provides a recommended payment vehicle to the customer 202 for the potential transaction with the merchant. In some embodiments, this recommendation may be sent to the customer 202 via his/her customer system 204. In other embodiments, the recommendation may be sent to the customer 202 via text message, email, voice message, social networking message, or the like.

Once the customer 202 has received the recommended payment vehicle, he/she may utilize it for the transaction with the merchant. In other embodiments, as illustrated in block 418, the system may, upon receiving an indication from the customer 202, complete the transaction by applying the recommended payment vehicle to the transaction. In this way, the system may communicate the recommended payment vehicle to the merchant to initiate payment of the transaction using the recommended payment vehicle.

FIG. 5 illustrates a process map for retroactive recommendation of payment vehicle set-up process 500, in accordance with one embodiment of the present invention. As illustrated in block 502, the process 500 may be initiated when a customer 202 enrolls in the retroactive recommendation of payment vehicle process. The customer 202 may be able to enroll in the program by selecting a link provided by the financial institution to download an application on the customer system or to enroll through an online banking application provided by the financial institution or through the other financial institution systems 210.

Next, as illustrated in block 504 a determination of the available payment vehicles based on customer 202 input or system determination. In some embodiments, the customer 202 may input the payment vehicles he/she has available, irrespective of the issuing entity. In some embodiments, the system may be able to determine the available payment vehicles. Next, at block 506 the system may determine and review typical in-flow and out-flow associated with the customer 202. Customer 202 in-flows may include one or more financial aspects associated with the customer 202 flowing into the customer's accounts or payment vehicles on a daily/weekly/monthly/yearly basis. In this way, the in-flow may include one or more paychecks, realized gains, checks, deposits, or other monetary in-flow. In-flow may also include typical customer 202 savings or money management routines. Customer 202 out-flow may include one or more financial aspects associate with the customer 202 flowing out of the customer's accounts or payment vehicles. In this way, the out-flows may include one or more payments for expenses, taxes, bills, or the like that are typically flowing out from the customer 202 on a daily/weekly/monthly/yearly basis. Furthermore, not only are in-flows and out-flows reviewed, customer 202 transaction history may be included in the out-flows, such that the system may recognize trends associated with purchases from various merchants. Next, as illustrated in block 510, the system provides the customer 202 with means to input customer criteria, if necessary. Next, as illustrated in block 508, the system receives an indication of a customer 202 transaction with a merchant. This may be when a customer 202 has initiated a transaction with a merchant. Finally, as illustrated in block 512, the set up for the retroactive recommendation of payment vehicle process 500 is completed.

FIG. 6 illustrates a process map for a retroactive recommendation of payment vehicle process 600, in accordance with one embodiment of the present invention. In this way, retroactive recommendation of payment vehicle process 600 allows for retroactive payment vehicle recommendations for a customer 202 transaction. In this way, the invention provides retroactive payment vehicle recommendation after the transaction based on criteria from customer inputs, in-flow, out-flow, or the like. In this way, in some embodiments, the invention may complete the transaction using a temporary line of credit, and subsequently apply the transaction to the recommended payment vehicle. Then the temporary line of credit may be terminated.

As illustrated in block 602, an indication is received of a completed transaction between the customer 202 and a merchant. As illustrated in block 604, the process 600 receives a list of products of the transaction. This may be communicated from the merchant or the customer 202. This may be a complete list of the products of the transaction and the total price of the transaction.

Next, as illustrated in block 603, in order to complete the transaction, the process 600 may allow the transaction to be applied to a temporary line of credit. In this way, the customer 202 may not have to provide a payment vehicle at the time of the transaction. Instead, a temporary line of credit may be issued for the transaction. As such, the transaction may later be applied to a recommended payment vehicle of the customer 202. In this way, the customer 202 may complete a transaction by utilizing a temporary line of credit to satisfy the transaction.

As illustrated in block 605, the process 600 may again allow the customer 202 input means for again inputting criteria associated with the transaction. As such, the customer 202 may input more criteria, however this criteria may include more transaction specific information such as what the products of the transaction are for, near future plans for the customer 202, updates to prior inputted criteria, and/or the like.

Next, as illustrated in block 606, the system may determine a recommended payment vehicle for the transaction after the transaction has been completed with the temporary line of credit. The recommended payment vehicle for the transaction is determined based on one or more of inputted customer criteria 608 (either provided during set up and/or after the transaction), typical in-flow 612, and typical out-flow 614, which are described in more detail above.

Next, as illustrated in block 616, the process retroactively provides a recommended payment vehicle to the customer 202 for the completed transaction with the merchant. In some embodiments, this recommendation may be sent to the customer 202 via his/her customer system 204. In other embodiments, the recommendation may be sent to the customer 202 via text message, email, voice message, social networking message, or the like. In yet other embodiments, the recommended payment vehicle may be automatically applied to cover the temporary line of credit utilized for the transaction. If no temporary line of credit was utilized for the transaction, the system may apply the recommended vehicle to the transaction automatically. Finally, as illustrated in block 618 the transaction may be applied to the recommended payment vehicle. In some embodiments, the transaction may be directly applied to the recommended payment vehicle, if no temporary line of credit was used. In some embodiments, the recommended payment vehicle may be utilized to cover the temporary line of credit that initially was applied to cover the transaction at the merchant.

FIG. 7 illustrates a process map for a rewards based recommendation of payment vehicle set up process 700, in accordance with one embodiment of the present invention. First, as illustrated in block 702 the process 700 may be initiated when a customer 202 enrolls in the rewards based recommendation of payment vehicle process. The customer 202 may be able to enroll in the program by selecting a link provided by the financial institution to download an application on the customer system or to enroll through an online banking application provided by the financial institution or through the other financial institution systems 210.

Next, as illustrated in block 704 the system may determine the customer's available payment vehicles based on customer 202 input and/or system determined. Next, at block 706, the system may determine reward criteria for each of the one or more available payment vehicles a customer 202 may have. The rewards for each of the one or more payment vehicles may include, but is not limited to cash back rewards, discounts, coupons, frequent flyer miles, points, balance transfer bonuses, product rewards, and/or the like. Finally, as illustrated in block 708, the set up for the rewards based recommendation of payment vehicle process 700 is completed.

FIG. 8 illustrates a process map for a rewards based recommendation of payment vehicle process 800, in accordance with one embodiment of the present invention. In this way, the recommended payment vehicle may be determined based on payment vehicle rewards. As such, the invention allows for payment vehicle recommendations for a customer transaction based on potential rewards available for the one or more payment vehicles the customer has available for a transaction. For example, if a customer receives three times rewards for purchasing products using one payment vehicle versus two times rewards for purchasing the product with a second payment vehicle, the invention may recommend the vehicle based on the higher rewards for the products of the transaction.

As illustrated in block 802, an indication is received of a transaction between the customer 202 and a merchant. As illustrated in block 804, the process 800 determines the products of the transaction, as such the system receives a list of products of the transaction. This may be communicated from the merchant or the customer 202. This may be a complete list of the products of the transaction and the total price of the transaction.

Next, as illustrated in block 806, the system may determine the payment vehicle rewards associated with the merchant and or the products of the transaction. While the system may determine rewards in the set up process, as illustrated above in FIG. 7, the system may monitor and get up-to-date reward information for each of the available payment vehicles for a customer 202 at the time of the transaction. The rewards for each of the one or more payment vehicles may include, but is not limited to cash back rewards, discounts, coupons, frequent flyer miles, points, balance transfer bonuses, product rewards, and/or the like. In this way, the system may communicate with issuing entities for the payment vehicles to determine the rewards for each of the one or more available payment vehicles. The system may continually communicate with issuing entities such that changes in rewards, special promotional periods, or the like may be recognized by the system.

Based on the rewards for each of the customer's payment vehicles, the system may, as illustrated in block 808, determine a recommended payment vehicle for the transaction based on the determined rewards.

Next, as illustrated in block 810, the process provides a recommended payment vehicle to the customer 202 to complete the transaction with the merchant. In some embodiments, this recommendation may be sent to the customer 202 via his/her customer system 204. In other embodiments, the recommendation may be sent to the customer 202 via text message, email, voice message, social networking message, or the like. Finally, as illustrated in block 812 the transaction may be applied to the recommended payment vehicle. In some embodiments, the transaction may be directly applied to the recommended payment vehicle by the system. In some embodiments, the recommended payment vehicle may be utilized by the customer 202 to complete the transaction with the merchant.

FIG. 9 illustrates a process map for a social network based recommendation of payment vehicle set up process 900, in accordance with one embodiment of the present invention. First, as illustrated in block 902 the process 900 may be initiated when a customer 202 enrolls in the social network data based recommendation of payment vehicle process. The customer 202 may be able to enroll in the program by selecting a link provided by the financial institution to download an application on the customer system or to enroll through an online banking application provided by the financial institution or through the other financial institution systems 210.

Next, as illustrated in block 904 the system may determine the customer's available payment vehicles based on customer 202 input and/or system determined. Next, at block 906, the system may review customer 202 social network data, such as social network inputs/connection or the like. Social network data may include one or more of preferences of a trusted advisor, social network friend, family member, celebrity, or an aggregation of data related to how a group of individuals on a social network as well as following/followers, posts, likes, messages, links, or the like associated with the advisor, friend, family member, celebrity, or group of individuals. Furthermore, the connections associated with the advisor, friend, family member, celebrity, or group of individuals may also be analyzed as social network data.

As illustrated in block 908, the system may determine defaults for payment vehicle selection. These payment defaults may include one or more customer 202 preferred payment vehicles or social network data established preferred payment vehicles. Finally, as illustrated in block 910, the set up for the social network based recommendation of payment vehicle process 900 is completed.

FIG. 10 illustrates a process map for a social network based recommendation of payment vehicle process 1000, in accordance with one embodiment of the present invention. In this way, the recommended payment vehicle may be determined based on social network data. As such, the invention allows for payment vehicle recommendations for a customer transaction based on social network data associated with the customer. A payment recommendation may be based on one or more preferences of a trusted advisor, social network friend, family member, celebrity, or an aggregation of data related to how a group of individuals on a social network are selecting payment vehicles for various merchants.

As illustrated in block 1002, an indication is received of a transaction between the customer 202 and a merchant. As illustrated in block 1004, the process 1000 determines the products of the transaction, as such the system receives a list of products of the transaction. This may be communicated from the merchant or the customer 202. This may be a complete list of the products of the transaction and the total price of the transaction.

Next, as illustrated in block 1006, may determine a recommended payment vehicle for the transaction based on the social network data. The determined recommended payment vehicle for the transaction is based on social network data 1008. The social network data 1008 may include one or more of followers/following 1010 on social network cites, preferences of a trusted advisors 1012, social network friend, family member, celebrity, or other contracts 1014, or an aggregation of data related to how a group of individuals on a social network 1016. In this way, social network data includes posts, likes, messages, links, or the like associated with the advisor, friend, family member, celebrity, or group of individuals. Furthermore, the connections associated with the advisor, friend, family member, celebrity, or group of individuals may also be analyzed as social network data.

For example, if one or more of the friends or social network connections of the customer 202 indicate on social network websites that they have purchased Product 1 with Credit Card 2, than Credit Card 2 may be a recommendation to the customer 202 if he/she is in a transaction with a merchant for Product 1.

In some embodiments, there may be one or more recommended payment vehicles for a transaction based on social network data. As such, some social network data may indicate Credit Card 1 for a transaction purchase while other social network data may indicate Credit Card 2, Credit Card 3, or Debit Card 1 for the same transaction. In this way, the system may provide one or more recommendations. Furthermore, the one or more recommendations may be provided in an order, such as a most preferred order of recommended payment vehicles or the like. This order may be determined by the preferences of the customer 202 or customer's closest social network connections.

Next, as illustrated in block 1016, the process provides a recommended payment vehicle to the customer 202 to complete the transaction with the merchant. In some embodiments, this recommendation may be sent to the customer 202 via his/her customer system 204. In other embodiments, the recommendation may be sent to the customer 202 via text message, email, voice message, social networking message, or the like. Finally, as illustrated in block 1018 the transaction may be applied to the recommended payment vehicle. In some embodiments, the transaction may be directly applied to the recommended payment vehicle by the system. In some embodiments, the recommended payment vehicle may be utilized by the customer 202 to complete the transaction with the merchant.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for recommending a payment vehicle for a transaction based on social network data, the system comprising:
a memory device with computer-readable program code stored thereon;
a communication device;
a processing device operatively coupled to the memory device and the communication device, wherein the processing device is configured to execute the computer-readable program code to:
determine one or more payment vehicles available to a customer;
review social network data associated with the customer;
receive an indication of a potential transaction between the customer and a merchant;
determine transaction details associated with the potential transaction between the customer and the merchant, wherein the transaction details include merchant type and products of the potential transaction;
determine a recommended payment vehicle for the potential transaction, wherein the recommended payment vehicle is determined based at least in part on the one or more payment vehicles available to the customer, the social network data associated with the customer, and the transaction details;
determine that the transaction has been initiated between the customer and the merchant;
provide the customer with the recommended payment vehicle before the transaction has been completed between the customer and the merchant; and
apply the recommended payment vehicle to the transaction to complete the transaction, wherein applying the recommended payment vehicle to the transaction is based at least in part on customer authorization.

2. The system of claim 1, wherein social network data associated with the customer comprises one or more preferences of customer social network connections, such as a trusted advisor, social network friend, social network following, or aggregate of preferences of a social network group.

3. The system of claim 2, wherein social network data associated with the customer further comprises posts, likes, messages, or links on a social network associated with the customer social network connections.

4. The system of claim 2, wherein determining a recommended payment vehicle for the potential transaction further comprises determining a payment vehicle that the customer social network connections have used in a similar transaction with the merchant or a similar transaction for a product of the transaction.

5. The system of claim 1, wherein an indication of a potential transaction between the customer and a merchant is determined by one or more customer location identification, customer communication, merchant communication, or social network data.

6. The system of claim 1, wherein determining the one or more payment vehicles available to the customer further comprises determining, automatically, the one or more payment vehicles available to the customer based on social network data or customer inputs, wherein the one or more payment vehicles available to the customer comprise cash, credit card account, a debit card account, a line of credit account, a retail card, a savings account, an investment account, or a line of credit.

7. The system of claim 1 further comprising receiving a customer enrollment indication such that the customer authorizes access to the payment vehicles available to the customer and the social network data associated with the customer.

8. A computer program product for recommending a payment vehicle for a transaction based on social network data, the computer program product comprising at least one non-transitory computer-readable medium having computer-readable program code portions embodied therein, the computer-readable program code portions comprising:
an executable portion configured for determining one or more payment vehicles available to a customer;
an executable portion configured for reviewing social network data associated with the customer;
an executable portion configured for receiving an indication of a potential transaction between the customer and a merchant;
an executable portion configured for determining transaction details associated with the potential transaction between the customer and the merchant, wherein the transaction details include merchant type and products of the potential transaction;
an executable portion configured for determining a recommended payment vehicle for the potential transaction, wherein the recommended payment vehicle is determined based at least in part on the one or more payment vehicles available to the customer, the social network data associated with the customer, and the transaction details;
determining that the transaction has been initiated between the customer and the merchant;
an executable portion configured for providing the customer with the recommended payment vehicle before the transaction has been completed between the customer and the merchant; and
an executable portion configured for applying the recommended payment vehicle to the transaction to complete the transaction, wherein applying the recommended payment vehicle to the transaction is based at least in part on customer authorization.

9. The computer program product of claim 8, wherein social network data associated with the customer comprises one or more preferences of customer social network connections, such as a trusted advisor, social network friend, social network following, or aggregate of preferences of a social network group.

10. The computer program product of claim 9, wherein social network data associated with the customer further comprises posts, likes, messages, or links on a social network associated with the customer social network connections.

11. The computer program product of claim 9, wherein determining a recommended payment vehicle for the potential transaction further comprises determining a payment vehicle that the customer social network connections have used in a similar transaction with the merchant or a similar transaction for a product of the transaction.

12. The computer program product of claim 8, wherein an indication of a potential transaction between the customer and a merchant is determined by one or more customer location identification, customer communication, merchant communication, or social network data.

13. The computer program product of claim 8, wherein determining the one or more payment vehicles available to the customer further comprises determining, automatically, the one or more payment vehicles available to the customer based on social network data or customer inputs, wherein the one or more payment vehicles available to the customer comprise cash, credit card account, a debit card account, a line of credit account, a retail card, a savings account, an investment account, or a line of credit.

14. The computer program product of claim 8 further comprising an executable portion configured for receiving a customer enrollment indication such that the customer authorizes access to the payment vehicles available to the customer and the social network data associated with the customer.

15. A computer-implemented method for recommending a payment vehicle for a transaction based on social network data, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
determining one or more payment vehicles available to a customer;
reviewing social network data associated with the customer;
receiving an indication of a potential transaction between the customer and a merchant;
determining transaction details associated with the potential transaction between the customer and the merchant, wherein the transaction details include merchant type and products of the potential transaction;
determining, via a computer processing device, a recommended payment vehicle for the potential transaction, wherein the recommended payment vehicle is determined based at least in part on the one or more payment vehicles available to the customer, the social network data associated with the customer, and the transaction details;
determining that the transaction has been initiated between the customer and the merchant;
providing the customer with the recommended payment vehicle before the transaction has been completed between the customer and the merchant; and
applying the recommended payment vehicle to the transaction to complete the transaction, wherein applying the recommended payment vehicle to the transaction is based at least in part on customer authorization.

16. The computer-implemented method of claim 15, wherein social network data associated with the customer comprises one or more preferences of customer social network connections, such as a trusted advisor, social network friend, social network following, or aggregate of preferences of a social network group.

17. The computer-implemented method of claim 16, wherein social network data associated with the customer further comprises posts, likes, messages, or links on a social network associated with the customer social network connections.

18. The computer-implemented method of claim 16, wherein determining a recommended payment vehicle for the potential transaction further comprises determining a payment vehicle that the customer social network connections have used in a similar transaction with the merchant or a similar transaction for a product of the transaction.

19. The computer-implemented method of claim 15, wherein an indication of a potential transaction between the customer and a merchant is determined by one or more customer location identification, customer communication, merchant communication, or social network data.

20. The computer-implemented method of claim 15, wherein determining the one or more payment vehicles available to the customer further comprises determining, automatically, the one or more payment vehicles available to the customer based on social network data or customer inputs, wherein the one or more payment vehicles available to the customer comprise cash, credit card account, a debit card account, a line of credit account, a retail card, a savings account, an investment account, or a line of credit.

21. The computer-implemented method of claim 15 further comprising receiving a customer enrollment indication such that the customer authorizes access to the payment vehicles available to the customer and the social network data associated with the customer.
